(19) United States
(12) Patent Application Publication
(10) Pub. No.: US 2025/0337540 A1
(43) Pub. Date: Oct. 30, 2025

(54) EXTENDED RANGE SIGNALING FIELD FOR WIRELESS COMMUNICATIONS

(71) Applicant: NXP USA, INC., AUSTIN, TX (US)

(72) Inventors: Rui Cao, Sunnyvale, CA (US); Rong Zhang, San Jose, CA (US); Hongyuan Zhang, Fremont, CA (US)

(21) Appl. No.: 18/983,540

(22) Filed: Dec. 17, 2024

Related U.S. Application Data
(60) Provisional application No. 63/640,413, filed on Apr. 30, 2024.
(60) Provisional application No. 63/668,739, filed on Jul. 8, 2024.
(60) Provisional application No. 63/682,601, filed on Aug. 13, 2024.

(51) Int. Cl. H04L 5/00; H04L 1/18; H04L 69/08; H04W 28/06

(52) U.S. Cl. CPC H04L 5/0048; H04L 1/18; H04L 5/0007; H04L 69/08; H04W 28/06

(57) ABSTRACT

Methods and apparatus are described for performing Enhanced Long Range (ELR) wireless communications. In a method, a wireless device generates a legacy portion of an ELR physical layer protocol data unit (PPDU), the legacy portion including at least a legacy short training field (L-STF), a legacy long training field (L-LTF), a legacy signal (L-SIG) field, and a universal signaling (U-SIG) field. The wireless device further generates an ELR portion of the ELR PPDU, the ELR portion including at least a UHR short training field (UHR-STF), a UHR long training field (UHR-LTF), an ELR signal (ELR-SIG) field, and a data field, wherein the ELR-SIG field includes an ELR-SIG-1 subfield and an ELR-SIG-2 subfield. The legacy portion of the ELR PPDU may further include an ELR-MARK field having a BSS color indication. The wireless device transmits the ELR PPDU over a wireless interface for reception by a second device.

### CROSS REFERENCE TO RELATED APPLICATIONS

The present U.S. Utility Patent Application claims priority pursuant to 35 U.S.C. § 119(e) to U.S. Provisional Application No. 63/640,413, entitled “EXTENDED RANGE SIGNALING FIELD DESIGN”, filed Apr. 30, 2024, U.S. Provisional Application No. 63/668,739, entitled “EXTENDED RANGE SIGNALING FIELD DESIGN”, filed Jul. 8, 2024, and U.S. Provisional Application No. 63/682,601, entitled “EXTENDED RANGE SIGNALING FIELD DESIGN”, filed Aug. 13, 2024, each of which is hereby incorporated herein by reference in its entirety and made part of the present U.S. Utility Patent Application for all purposes.

### BACKGROUND

### Technical Field

This disclosure relates generally to wireless communications, and more specifically to range extension in wireless communications.

### Description of Related Art

Wireless local area networks (WLANs) have evolved rapidly over the past couple of decades, including WLANs that conform to the Institute of Electrical and Electronics Engineers (IEEE) 802.11 family of standards. In such WLANs, wireless devices such as Access Points (APs) and client stations (STAs) wirelessly transmit and receive physical layer protocol data units (PPDUs). As various new services and deployment scenarios are supported by these wireless devices, the devices may need to be able to transmit and receive signals over longer ranges. To extend the range that the PPDUs are transmitted and received, the IEEE 802.11ax and IEEE 802.11be amendments to the IEEE 802.11 standard define an extended range PPDU. While the extended range PPDU may improve a reception range compared to a conventional PPDU, the range is still somewhat limited in the 5 GHz and 6 GHz wireless bands due to higher propagation losses and regulatory limits on power spectrum density. The IEEE 802.11b amendment also describes direct sequence spread spectrum (DSSS) communications to support an extended range, but practical applications are limited due to low data rates.

### BRIEF DESCRIPTION OF THE DRAWINGS

One or more embodiments will now be described by way of example only with reference to the accompanying drawings, in which:

FIG. 1 illustrates an example of a wireless local area network (WLAN) in accordance with embodiments of the present disclosure;

FIG. 2A illustrates an example of an Enhanced Long Range (ELR) physical layer protocol data unit (PPDU) in accordance with embodiments of the present disclosure;

FIG. 2B illustrates another example of an ELR PPDU in accordance with embodiments of the present disclosure;

FIG. 3A illustrates an ELR signal (ELR-SIG) field in accordance with embodiments of the present disclosure;

FIG. 3B illustrates another example of an ELR-SIG field in accordance with embodiments of the present disclosure;

FIG. 4A illustrates an example of a single symbol ELR-SIG field in accordance with an embodiment of the present disclosure;

FIG. 4B illustrates another example of a single symbol ELR-SIG field in accordance with an embodiment of the present disclosure;

FIG. 4C illustrates another example of a single symbol ELR-SIG field in accordance with an embodiment of the present disclosure;

FIG. 4D illustrates another example of a single symbol ELR-SIG field in accordance with an embodiment of the present disclosure;

FIG. 4E illustrates another example of a single symbol ELR-SIG field in accordance with an embodiment of the present disclosure;

FIG. 5A illustrates an example of coding of an ELR-SIG field in accordance with an embodiment of the present disclosure;

FIG. 5B illustrates another example of coding of an ELR-SIG field in accordance with an embodiment of the present disclosure;

FIG. 5C illustrates another example of coding of an ELR-SIG field in accordance with an embodiment of the present disclosure;

FIG. 5D illustrates another example of coding of an ELR-SIG field in accordance with an embodiment of the present disclosure;

FIG. 6 illustrates an example of an ELR-SIG field in which some subfields are jointly coded with data in accordance with an embodiment of the present disclosure;

FIG. 7 illustrates an example of a universal signaling (U-SIG) field in accordance with an embodiment of the present disclosure;

FIG. 8 illustrates an example of a EHT signaling (EHT-SIG) field in accordance with an embodiment of the present disclosure;

FIG. 9 illustrates an example of a User Info subfield in accordance with an embodiment of the present disclosure;

FIG. 10 is a logic diagram illustrating an example process for generating a ELR PPDU in accordance with an embodiment of the present disclosure; and

FIG. 11 illustrates example functions associated with single carrier-frequency division multiplexed transmission in accordance with an embodiment of the present disclosure.

### DETAILED DESCRIPTION

The various implementations described in the following description relate generally to extended range physical layer protocol data units (PPDU) formats to support new wireless communication protocols, and more particularly to Enhanced Long Range (ELR) PPDU formats that support extended range wireless communication features associated with the IEEE 802.11bn amendment (also referred to as Ultra High Reliability or “UHR” or “Wi-Fi 8”), and future generations, of the IEEE 802.11 standard while also providing coexistence with legacy wireless devices. In some aspects, a wireless device generates a legacy portion of an ELR physical layer protocol data unit (PPDU) including a legacy short training field (L-STF), a legacy long training field (L-LTF), a legacy signal (L-SIG) field, and a universal signaling (U-SIG) field. The wireless device further generates an ELR portion of the ELR PPDU, the ELR portion including a UHR short training field (UHR-STF), a UHR long training field (UHR-LTF), an ELR signal (ELR-SIG) field, and a data field. The ELR-SIG field can include an ELR-SIG-1 subfield and an ELR-SIG-2 subfield (e.g., in separate symbols), and the legacy portion of the ELR PPDU can further include an ELR-MARK field having a BSS color indication.

As used herein, the term “non-legacy” may refer to frame structures, physical layer (PHY) protocol data unit (PPDU) formats and communication protocols conforming with the IEEE 802.11bn amendment to the IEEE 802.11 standard (“802.11bn”) as well as future generations/amendments. In contrast, the term “legacy” may be used herein to refer to frame structures, PPDU formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11 standard, or earlier generations of the IEEE 802.11 standard, but not conforming to all mandatory features of 802.11bn or future generations of the IEEE 802.11 standard.

Particular implementations of the subject matter described in the present disclosure can be implemented to realize one or more of the following potential advantages. By enabling extended range communications, aspects of the described subject matter may support gains in data throughput and reliability achievable in accordance with various features of the IEEE 802.11bn amendment to the IEEE 802.11 standard. Among other examples, an ELR PPDU according to the present disclosure may be used to overcome a link budget imbalance between downlink and uplink wireless communications and achieve higher data rates as compared to legacy extended range PPDU formats and protocols.

In an example, an ELR PPDU is transmitted by an AP device to a client station which is able to decode an extended range portion of the ELR PPDU when the client station might not be able to decode a legacy portion of the ELR PPDU. In this example, at least some fields of the legacy portion may be defined by IEEE 802.11be or 802.11ax such that legacy devices compliant with IEEE 802.11a/g/n/ac/ax/be have the capability to decode the legacy portion of the new ELR PPDU and perform corresponding clear channel assessment (CCA) for better coexistence with UHR devices. Based on a receiver not being able to decode the legacy portion of the PPDU, the receiver attempts to decode the ELR portion. The ELR portion of the PPDU is appended to the legacy portion, and may include one or more repetitions of one or more of a UHR-STF, a UHR-LTF, an ELR-SIG field, and an UHR data field. The repetition may be in time, in frequency within a channel bandwidth, or both in time and in frequency. In an example, a time domain repetition of the UHR-STF includes a polarity change of one or more waveforms representative of one or more bits of a binary sequence in the UHR-STF and in symbols of the UHR-LTF, and the ELR-SIG field and UHR data field are repeated by repeating a respective binary sequence in resource units (RUs) of symbols (e.g., in accordance with a dual carrier modulation with duplication (DCM+DUP) with a 106-tone, 52-tone, or 26-tone resource unit (RU)). The client station which receives the ELR-portion combines signals of the one or more repetitions for a given field to increase a signal to noise ratio (SNR) of the one or more fields in the ELR portion to facilitate the decoding. In an example, the repetition increases the SNR in a decoded signal by greater than 3 dB. Certain well known instructions, protocols, structures, and techniques have not been shown in detail in order not to obfuscate the description.

In a further example, the ELR PPDU formats described herein can be utilized in 2.4 GHz, 5 GHz, and 6 GHz bands for uplink communications, and in the 2.4 GHz band for downlink communications. In another example, a ELR PPDU may have a 20 MHz PPDU bandwidth, a single spatial stream, and utilize UHR-MCSs 0 or 1 with four times frequency domain duplication (e.g., over 52-tone RUs) in a primary 20 MHz channel.

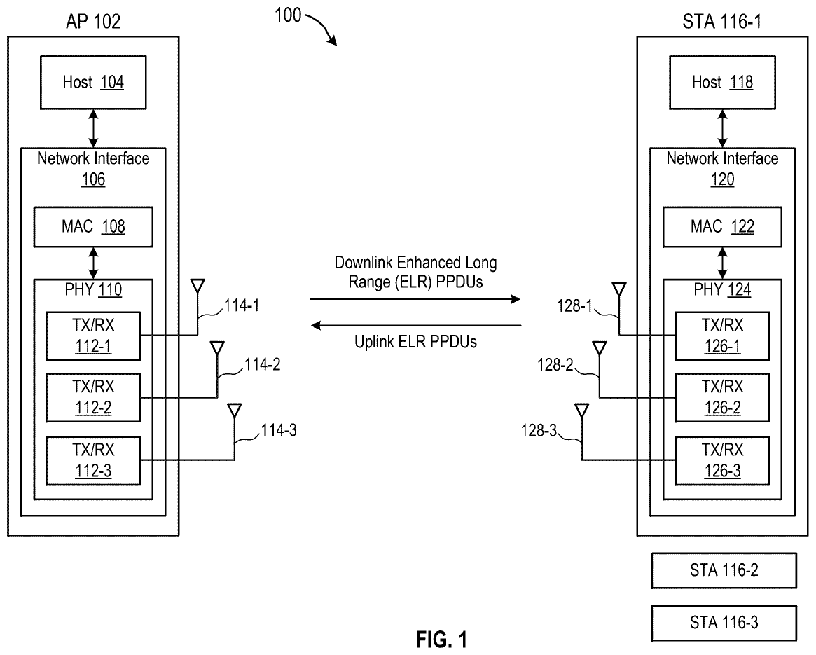

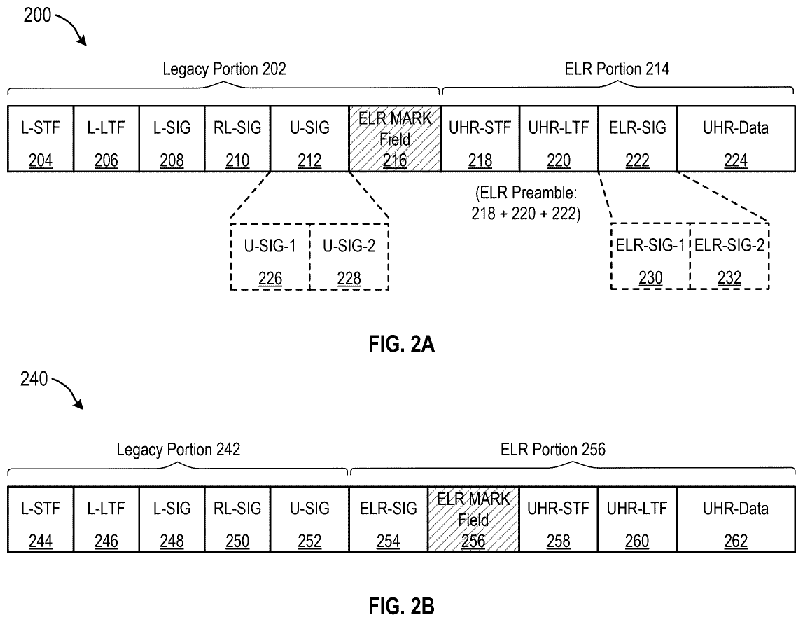

FIG. 1 illustrates an example of a wireless local area network (WLAN) 100 in accordance with embodiments of the present disclosure. The illustrated WLAN includes a wireless access point (AP) 102 and one or more wireless client stations 116 (e.g., 116-1, 116-2, and 116-3). The AP102 of this example is configured to transmit downlink Enhanced Long Range (ELR) PPDUs and receive uplink ELR PPDUs. The ELR PPDUs can have a format and contents such as described in greater detail below with reference to any of the embodiments FIG. 2A-FIG. 9.

The illustrated AP 102 includes a host processor 104 coupled to a network interface 106. The network interface 106 includes a medium access control (MAC) processing unit 108 and a physical layer (PHY) processing unit 110. The PHY processing unit 110 includes a plurality of transceivers 112-1, 112-2 and 112-3 (e.g., transmitters and/or receivers) coupled to a respective plurality of antennas 114-1, 114-2 and 114-3. Although three transceivers 112 and three antennas 114 are illustrated in FIG. 1, in other embodiments the AP 102 includes other suitable numbers (e.g., 1, 2, 4, 5, etc.) of transceivers 112 and antennas 114 in other embodiments. In one embodiment, the MAC processing unit 108 and the PHY processing unit 110 are configured to operate in compliance with the IEEE 802.11bn amendment to the IEEE 802.11 standard.

The illustrated WLAN 100 also includes one or more wireless client stations 116. Three client stations 116 shown as 116-1, 116-2, and 116-3 are illustrated in FIG. 1, but the WLAN 100 may include other suitable numbers (e.g., 1, 2, 3, 5, 6, etc.) of client stations 116 in various scenarios and embodiments. At least one of the client stations 116 (e.g., client station 116-1) is configured to operate in compliance with the IEEE 802.11bn amendment to the IEEE 802.11 standard to communicate with the AP 102.

The client station 116-1 includes a host processor 118 coupled to a network interface 120 which includes a MAC processing unit 122 and a PHY processing unit 124. The PHY processing unit 124 includes a plurality of transceivers 126-1, 126-2 and 126-3, and the transceivers 126 are coupled to a respective plurality of antennas 128-1, 128-2 and 128-3. Although three transceivers 126 and three antennas 128 are illustrated in FIG. 1, the client station 116-1 includes other suitable numbers (e.g., 1, 2, 4, 5, etc.) of transceivers 126 and antennas 128 in other embodiments.

In various embodiments, the PHY processing unit 110 of the AP 102 is configured to generate and transmit (downlink) data units via the antenna(s) 144 over an air interface and the PHY processing unit 124 of the client station 116-1 is configured to receive the (downlink) data units via the antenna(s) 128 over the air interface. Similarly, the PHY processing unit 110 of the client station 116-1 is configured to generate and transmit (uplink) data units via the antenna(s) 128 and the PHY processing unit 110 of the AP 102 is configured to receive the (uplink) data units via the antenna(s) 124. In an example, the data units may be physical layer data units (PPDUs) for communicating data between the AP 102 and the client station 116-1 and the PPDUs (and fields therein) may be transmitted as a waveform in a downlink or uplink direction.

In embodiments, the network interface 106 of the AP 102 and the network interface 120 of one or more of the client stations 116 are configured to generate, transmit and receive ELR PPDUs having an extended range format to increase a range and/or a signal-to-noise (SNR) ratio associated with transmitting, receiving, and successfully decoding the ELR PPDUs exchanged in the WLAN 100. In an example, the ELR PPDUs are compliant with the IEEE 802.11bn (or later) amendment to the IEEE 802.11 standard, and include a legacy portion with legacy fields of one or more legacy IEEE 802.11 standards for backwards compatibility with legacy devices and an enhanced long range (ELR) portion with non-legacy fields of a non-legacy IEEE 802.11 standard which can be decoded by non-legacy devices. In an example, various of the fields of an ELR PPDU are repeated in a time domain and/or duplicated in a frequency domain to increase a range and/or SNR associated with transmission and reception of data in the ELR portion of the ELR PPDUs. In another example, the ELR PPDU may be a trigger frame which is transmitted by the AP device 102 and which is received by the client station 116 in a downlink direction.

The range extension features of the ELR PPDU may allow a client station 116 to decode the ELR portion of the ELR PPDU at an extended range. Decoding is a process of determining a valid pattern of bits of the received ELR PPDU referred to as decoded bits. In an example, the decoding may involve performing a parity check or CRC which determines whether the decoding is successful or is not successful. A downlink ELR PPDU transmitted by AP 102 may solicit a response from a client station 116 in the form of an uplink ELR PPDU.

In an embodiment, when operating in single-user mode, the AP 102 transmits a data unit to a single client station (DL SU transmission), or receives a data unit transmitted by a single client station (UL SU transmission), without simultaneous transmission to, or by, any other client station. When operating in multi-user mode, the AP 102 transmits a data unit that includes multiple data streams for multiple client stations (DL MU transmission), or receives data units simultaneously transmitted by multiple client stations (UL MU transmission). For example, in multi-user mode, a data unit transmitted by the MLD includes multiple data streams simultaneously transmitted by the AP 102 to respective client stations using respective spatial streams allocated for simultaneous transmission to the respective client stations and/or using respective sets of OFDM tones corresponding to respective frequency sub-channels allocated for simultaneous transmission to the respective client stations. In a further example, the AP 102 and/or client station(s) 116 may be configured as a multi-link device (MLD). In another example, the AP 102 and/or one or more of the client stations 116 are configured to transmit and receive PPDUs over a plurality of wireless links, including one or more of a 2.4 Gigahertz (GHz) link, a 5 GHz link, a 6 GHz link, and a mmWave link (e.g., a 45 GHz link and/or a 60 GHz link).

In an example, the illustrated AP 102 may be connected to a distribution system (DS) through a distribution system medium (DSM). The distribution system may be a wired network or a wireless network that is connected to a backbone network such as the Internet. The DSM may be a wired medium (e.g., Ethernet cables, telephone network cables, or fiber optic cables) or a wireless medium (e.g., infrared, broadcast radio, cellular radio, or microwaves). Although some examples of the DSM are described, the DSM is not limited to the examples described herein. In another example, the AP 102 and/or client stations 116 may be implemented in a laptop, a desktop personal computer (PC), a mobile phone, or other communications device that supports at least one WLAN communications standard (e.g., at least one IEEE 802.11 standard).

In an example, one or more of the AP 102 and client stations 116 may be implemented with circuitry such as one or more of analog circuitry, mixed signal circuitry, memory circuitry, logic circuitry, and processing circuitry that executes code stored in a memory that when executed by the processing circuitry performs the disclosed functions. For example, the AP 102 and client stations 116 may include memory storing operational instructions (software, program instructions, computer instructions, etc.) and one or more processing modules, operably coupled to one or more wireless transceivers and the memory, configured to execute the operational to generate an ELR PPDU.

In another example, a network interface 106/120 includes one or more integrated circuit (IC) devices. In this example, at least some of the functionality of a MAC processing unit 108/122 and at least some of the functionality of the PHY processing unit 110 can be implemented on a single IC device. As another example, at least some of the functionality of the MAC processing unit 108 is implemented on a first IC device, and at least some of the functionality of the PHY processing unit 110 is implemented on a second IC device.

FIG. 2A illustrates an example of an Enhanced Long Range (ELR) physical layer protocol data unit (PPDU) 200 in accordance with embodiments of the present disclosure. The ELR PPDU 200 of this example includes a legacy portion 202 and an ELR portion 214, which are transmitted as a waveform. The legacy portion 202 includes legacy fields which legacy 802.11 devices are able to decode for co-existence while the ELR portion 214 may include one or more ELR fields so that next generation devices (e.g., Wi-Fi 8 UHR devices) are able to transmit and receive data in the ELR portion 214 with increased range and lower SNR. In an example, a bandwidth of the legacy portion 202 and the ELR portion 214 is the same to provide co-existence with legacy devices.

The legacy portion 202 of this example includes a legacy short training field (L-STF) 204, a legacy long training field (L-LTF) 206, a legacy signal (L-SIG) field 208, a repeated L-SIG (RL-SIG) field 210, and a universal signaling (U-SIG) field 212. The L-STF 204 is used by a recipient device to detect the start of the PPDU or portion thereof and to establish orthogonal frequency division multiplexed/access (OFDM/A) symbol timing for data detection, i.e. frame acquisition and time synchronization. The L-LTF 206 is used for channel estimation/training for information detection. Channel estimation is a process of determining channel characteristics (e.g., a frequency response) of a channel in which the PPDU is transmitted. The L-SIG field 208 includes information for data decoding and coexistence such as a 12 bit packet length value (LENGTH), rate information, etc. In an example, LENGTH is signaled to spoof legacy devices for purposes of clear channel assessment (CCA), and non-legacy devices can decode a TXOP for CCA. In addition, a non-legacy device (e.g., an intended receiver) may also derive a Nsym (with may also be referred to as Length) value from the L_SIG field 208. However, as L-SIG LENGTH decoding may not be reliable, this information may be repeated in the ELR-SIG field 222. In an example, a number of data symbols (Nsym/Length) subfield can be directly signaled in the ELR-SIG field 222 utilizing fewer than 12 bits (e.g., 8 or 9 bits), thereby saving 3-4 bits of signaling and simplifying packet length calculations by receiving devices.

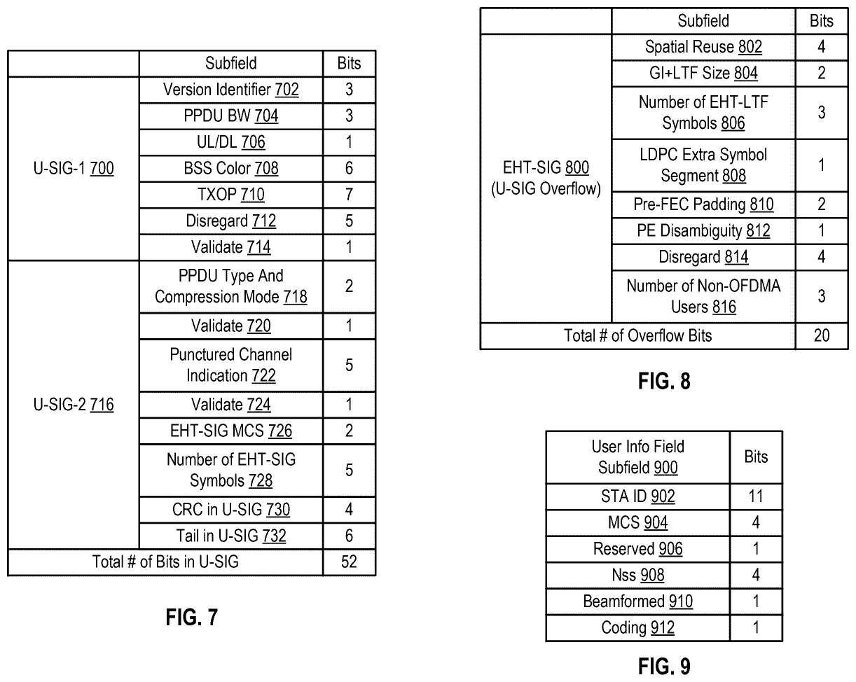

In an example, the L-SIG 208 may be repeated in time and the repetition is included in the repeated RL-SIG field 210 of the legacy portion 202 such that the L-SIG 208 is repeated twice. The repetition may allow increased range and SNR associated with receipt of the L-SIG field 208. The U-SIG field 212 in the legacy portion 202 may include an indication of a version of the physical layer communication of IEEE 802.11 such as in a three-bit PHY identifier, an uplink/downlink flag, Basic Service Set (BSS) color, transmission (TX) opportunity (TXOP) duration, bandwidth, etc. Like the L-SIG field, the U-SIG field 212 may also be repeated twice in time for better reception. In the illustrated ELR PPDU, the U-SIG field 212 includes a U-SIG-1 subfield 226 and a U-SIG-2 subfield 228, examples of which are described in greater detail with reference to FIG. 7. To also extend the range, a transmission power of a waveform of one or more of the L-STF 204 and the L-LTF 206 may be boosted to 3 dB.

To further extended the range, a transmission power associated with the L-STF 204 and L-LTF 206 could be boosted to greater than 3 dB and the L-SIG field 208 and the U-SIG field 212 may be repeated more than twice, but these changes may create compatibility issues with legacy devices because of energy drop-off between when the legacy device receives the L-SIG 208 and receives the L-LTF 206, erroneous detection of the L-SIG field 208 and U-SIG field 212, and a high peak to average power ratio of the PPDU. The legacy portion 202 may be modulated on an orthogonal frequency division multiplexed (OFDM) signal which defines subcarriers for transmitting the fields of the legacy portion 202 and as a result range extension is also limited by a maximum peak to average ratio (PAPR) of the waveform representing the PPDU which IEEE 802.11 specifies. IEEE 802.11b defines a single-carrier binary sequence design which demonstrates range extension benefits over OFDM associated with 802.11 ax and 802.11 be. However, the carrier is only defined for a 2.4 GHz band and does not co-exist with IEEE 802.11a such that the format cannot be extended into a 5 GHz and 6 GHz band without also causing backward compatibility issues for legacy devices.

In some examples, one or more transition symbols may be optionally added after the U-SIG field 212 in the legacy portion 202 preceding the ELR portion 214. In the illustrated example, an ELR-MARK field 216 is included. The ELR-MARK field 216 may be a symbol, such as an OFDM symbol, which spans a channel bandwidth and has a predefined duration, and may signal a transition between the U-SIG field 212 and the ELR portion 214. The optional nature of inclusion in the ELR PPDU 200 is illustrated by the cross-hatching. In an example, a non-legacy wireless device receiving the ELR PPDU 200 may need to determine a receiver state machine based on a U-SIG decoding CRC check. In the event that the U-SIG decoding fails, e.g., a CRC check does not pass, the wireless device needs to reset receive time domain parameters, such as CFO and sample frequency offset (SFO) compensation, while ELR preamble detection logic is still running. The ELR-MARK field 216 may provide some buffer time such that the ELR preamble will not arrive before the receive time domain parameters is reset. Thus, the ELR preamble detection will not be affected by the status of the legacy preamble detection. In one example, the ELR-MARK field 216 is defined as a signaling field (with predefined tone patterns), similar to EHT-SIG as in IEEE 802.11be. In another example, the ELR-MARK field 216 is a predefined sequence, which can further include a BSS color indication (e.g., a value of 0 to 63) for use by receiving devices to determine if the received PPDU is an ELR PPDU and if the ELR PPDU is from OBSS.

To achieve range extension, the legacy portion 202 is followed by the ELR portion 214. By appending the legacy portion 202 to the ELR portion 214, the ELR PPDU 200 is able to co-exist with the 802.11 legacy devices. In an example, a PPDU length in octets indicated in the L-SIG field 208 is backward compatible with legacy devices to detect the ELR PPDU 200 while the U-SIG field 212 provides both backward and forward compatibility. For example, the U-SIG field 212 is modulated with binary phase shift keying (BPSK), and the U-SIG field 212 may indicate a “PHY version identifier” which indicates a PHY version. To signal the new ELR format, a new value of “PHY version identifier” in the U-SIG field 212 can be used to indicate next generation PHY and a new “PPDU format” subfield can indicate the new ELR format. In an example, the ELR PPDU 200 may be limited for transmission over one spatial stream using modulation coding scheme (MCS) 0 or lower data rates. In an example, an unintended receiver which does not support a non-legacy standard can use indications of these fields to enter into a power save state when the ELR PPDU 200 is received and is not able to be processed, and set network allocation vector (NAV) values correspondingly to not transmit for at least a PPDU duration.

The ELR portion 214 of the illustrated example includes an ELR preamble and a UHR-Data field 224. The ELR preamble includes a UHR short training field (UHR-STF) 218, a UHR long training field (UHR-LTF) 220, and an ELR signal (ELR-SIG) field 222. The UHR-STF 218 may be a predefined binary sequence used to detect the start of the ELR portion 214 and provide symbol timing for data detection, i.e. frame acquisition and time synchronization. In one embodiment, the UHR-STF 218 consists of two parts: one binary sequence for synchronization followed by one binary sequence for STF ending and UHR-LTF 220 may not be included. In another embodiment, the UHR-STF 218 consists of one binary sequence followed by UHR-LTF 220. If the receiver is not able to detect the legacy STF 204, the receiver will attempt to detect the UHR-STF 218. The UHR-LTF 220 defines a binary sequence for channel estimation/training by a receiver. In some examples, this field may be omitted for certain modulation schemes such as differential encoding for 802.11b.

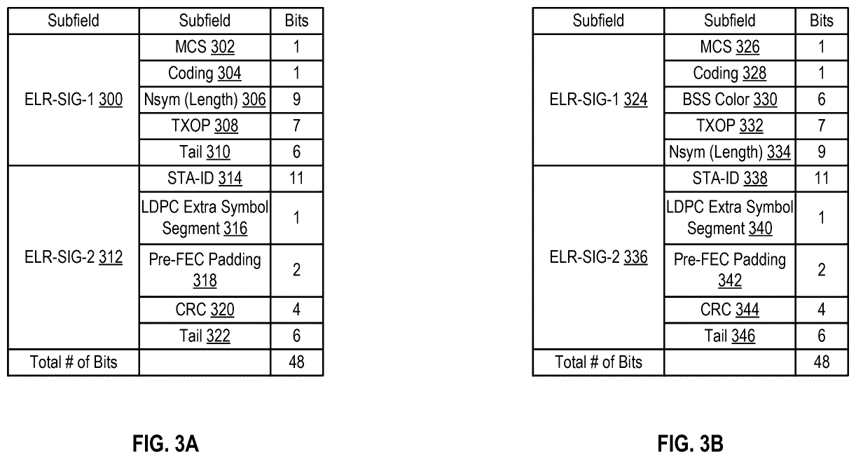

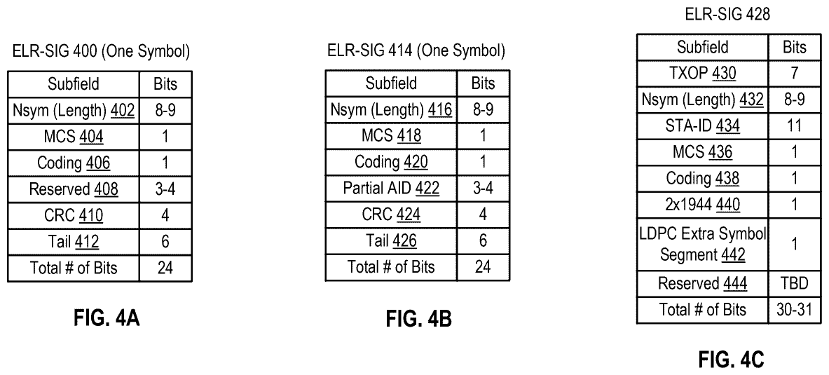

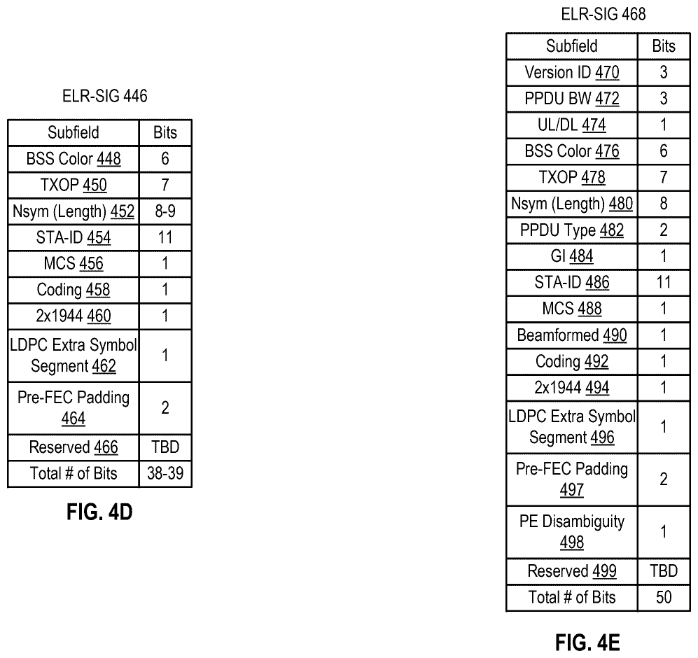

The ELR-SIG field 222 includes information for data decoding. The ELR-SIG field 222 may include various parameters including a modulation and coding scheme (MCS) subfield, a coding subfield that indicates whether BCC or LDPC is used, a number of symbols (Nsym) or Length subfield that indicates a number of ELR data symbols, a cyclic redundancy check (CRC), etc., defined by an ELR-SIG binary sequence. In an example, the ELR-SIG field 222 includes two symbols (i.e., an ELR-SIG-1 subfield 230 and an ELR-SIG-2 subfield 232). Various examples of the ELR-SIG field 222 are described herein with reference to FIGS. 3A-4E. Forward error correction (FEC) coding may be defined for the ELR-SIG field 222 to enhance reliability, e.g. binary convolutional coding (BCC). The UHR-Data field 224 which follows the ELR preamble includes a data payload defined by an ELR-data binary sequence. Forward error correction (FEC) coding may be defined to enhance data decoding reliability, e.g. BCC or low density parity check code (LDPC).

The ELR portion 214 may be transmitted in various ways. In one example, a waveform representative of the binary sequences of the ELR portion 214 may be defined with a low peak-to-average ratio (PAPR) such that the transmitter can increase the maximum transmit power to increase communication range or enhance receiver reception reliability. Because the legacy preamble 202 may already have a high PAPR, a power amplifier associated with the transceiver which transmits the ELR portion 214 may back off by ˜10 dB to keep all samples which are to be transmitted in a linear region to accommodate the PAPR. The power amplifier may transmit the ELR portion 214 with some peak samples into a non-linear region for range extension and an ER spectrum growth due to the non-linearity may result in a lower PAPR, close to 0 dB depending on binary sequence design. In an example, the ELR portion 214 may be transmitted with a power similar to a peak power of the legacy portion 202 with ˜10 dB gain, but in some cases, an increase in transmit power may be limited by a power spectral density. In another example, the transmit power of a waveform of the ELR portion 214 may be set to a power boost such as 3 dB or the transmitter may set a power boost based on a historical transmit power range.

The binary sequence of the UHR-STF 218 may be modulated on a time domain waveform. Time domain modulation is defined as varying a modulation of a waveform over time. The binary sequence of the UHR-LTF 220, ELR-SIG 222, and UHR-Data field 224 may be transmitted based on single carrier (SC) time-domain multiplexing (TDM). A binary sequence may be directly modulated on a time domain waveform to generate different time domain signals for different binary sequences and additional spreading can be applied, e.g. 802.11b direct sequence spread spectrum (DSSS).

In another example, the modulation of one or more of the fields in the ELR preamble may be based on a single carrier (SC) frequency-domain multiplexing (FDM). Frequency domain multiplexing is defined as loading binary sequences to be transmitted onto subcarriers in a frequency band versus time domain signals, where different frequency bands may be assigned to different wireless devices. The UHR-STF 218 may be transmitted with one of the 802.11b DSSS, a zero correlation zone (ZCZ) spreading sequence, or a Golay sequence (defined in 802.11ad/ay). The UHR-LTF 220 may include a predefined binary sequence to estimate a channel of each subcarrier and transmitted in a manner similar to the UHR-STF 218. The ELR-SIG field 222 and the UHR-Data field 224 may be transmitted with SC-FDM. An LTF1 subfield of UHR-LTF 220 may be added before the ELR-SIG field 222 to indicate information to demodulate SIG content and an LTF2 subfield of the UHR-LTF 220 may be added to indicate information to demodulate UHR-Data field 224 content. The information may indicate a tone mapping and the LTF2 may be included in the UHR-LTF 220 when a tone mapping of the subcarriers on which a binary sequence of the information are loaded and/or a bandwidth of the UHR-Data field 224 is different from the ELR-SIG field 222. The tone mapping may be a process of selecting subcarriers in a set of subcarriers to transmit the binary sequence, where a subcarrier or tone is a defined frequency or frequencies in a channel bandwidth such as a 20 MHz channel having an amplitude and a phase. In an example, a bit or bits of the sequence may be modulated on the tone such as by binary phase shift keying (BPSK) or quadrature phase shift keying (QPSK) to form a waveform.

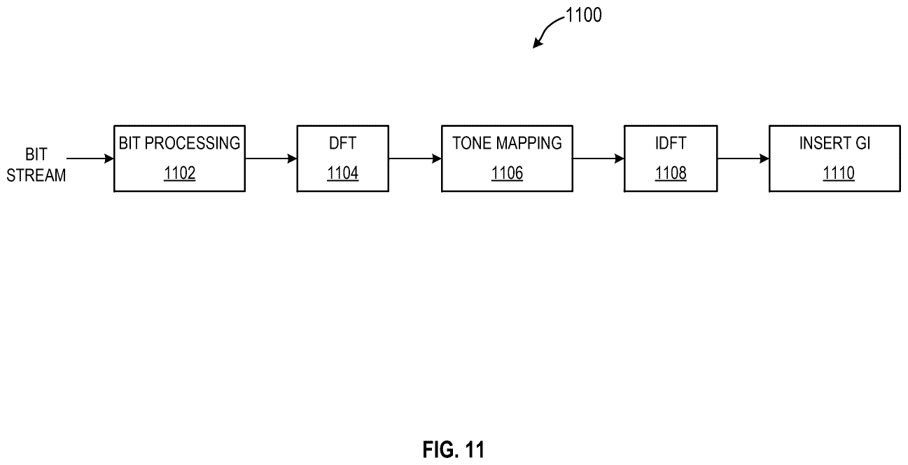

In the example of FIG. 2A, the ELR preamble may have a fixed transmission format as the ELR-SIG field 222 follows the UHR-STF 218 and UHR-LTF 220. For example (and as described in greater detail with reference to FIG. 11), the UHR-LTF 220 transmission format may be fixed at 4xLTF with 4 repetitions, 1xLTF with 16 repetitions, 4xLTF with sparse tone loading and 2 repetitions, etc.

FIG. 2B illustrates another example of an ELR PPDU 240 in accordance with embodiments of the present disclosure. The ELR PPDU 240 of this example includes a legacy portion 242 and an ELR portion 256, which are transmitted as a waveform. The legacy portion 242 includes legacy fields which legacy 802.11 devices are able to decode for co-existence while the ELR portion 256 may include one or more ELR fields so that next generation devices are able to transmit and receive data in the ELR portion 256 with increased range and lower SNR. In an example, a bandwidth of the legacy portion 242 and the ELR portion 256 is the same to provide co-existence with legacy devices.

The legacy portion 242 of this example includes a legacy short training field (L-STF) 244, a L-LTF 246, a L-SIG field 248, an RL-SIG field 250, and a universal signaling (U-SIG) field 252. These fields correspond to the fields of the legacy portion 202 of FIG. 2A. The ELR portion 256 of the illustrated example includes an ELR preamble and an UHR-Data field 264. The ELR preamble includes an ELR-SIG field 254, an ELR MARK Field 256, a UHR short training field (UHR-STF) 258, a UHR long training field (UHR-LTF) 260, and an ELR signal (ELR-SIG) field 262. The ELR MARK Field 256, UHR short training field (UHR-STF) 258, and UHR long training field (UHR-LTF) 260, and UHR-Data field 264 generally correspond to the similarly labeled fields of the ELR portion 214 of FIG. 2A, while the ELR-SIG field 254 precedes the ELR preamble fields and may include different subfields than ELR-SIG field 222. For example, when including the ELR-SIG field 254 before the ELR preamble fields, channel estimation information from the legacy tone plan (L-LTF 246, L-SIG field 248, RL-SIG field 250) may be utilized to detect ELR-SIG symbols.

FIG. 3A illustrates an ELR signal (ELR-SIG) field in accordance with embodiments of the present disclosure. In the illustrated example, the ELR-SIG field includes an ELR-SIG-1 subfield 300 and an ELR-SIG-2 subfield 312. The ELR-SIG-1 subfield 300 includes a number of subfields: an MCS subfield 302, a Coding subfield 304, a Nsym (or Length) subfield 306, a TXOP subfield 308, and a Tail bits subfield 310. The ELR-SIG-2 subfield 312 of this example includes an association ID (STA-ID) subfield 314, an LDPC Extra Symbol or Segment subfield 316, a Pre-FEC Padding subfield 318, a CRC subfield 320, and a Tail bits subfield 322. The total number bits of the ELR-SIG field of this example is 48 bits.

FIG. 3B illustrates another example of an ELR-SIG field in accordance with embodiments of the present disclosure. In the illustrated example, the ELR-SIG field includes an ELR-SIG-1 subfield 324 and an ELR-SIG-2 subfield 336. The ELR-SIG-1 subfield 324 includes a number of subfields: an MCS subfield 326, a Coding subfield 326, a BSS Color subfield 330, a TXOP subfield 332, and a Nsym (or Length) subfield 334. The ELR-SIG-2 subfield 336 of this example includes a STA-ID subfield 338, an LDPC Extra Symbol or Segment subfield 340, a Pre-FEC Padding subfield 342, a CRC subfield 344, and a Tail bits subfield 346. The total number bits of the ELR-SIG field of this example is 48 bits.

FIG. 4A illustrates an example of a single symbol ELR-SIG field 400 in accordance with an embodiment of the present disclosure. The ELR-SIG field 400 of the illustrated example includes a Nsym (or Length) subfield 402, an MCS subfield 404, a Coding subfield 406, a Reserved bits subfield 408, a CRC subfield 410, and a Tail bits subfield 412. The total number of bits of the ELR-SIG field 400 of this example is 24 bits.

FIG. 4B illustrates another example of a single symbol ELR-SIG field 414 in accordance with an embodiment of the present disclosure. The ELR-SIG field 414 of the illustrated example includes a Nsym (or Length) subfield 416, an MCS subfield 418, a Coding subfield 420, a Partial AID subfield 422 (e.g., LSBs of a full STA-ID), a CRC subfield 424, and a Tail bits subfield 426. The total number of bits of the ELR-SIG field 414 of this example is 24 bits. In an alternate embodiment, the bits of the Partial AID subfield 422 are reserved.

FIG. 4C illustrates another example of a single symbol ELR-SIG field 428 in accordance with an embodiment of the present disclosure. The ELR-SIG field 428 of the illustrated example includes a TXOP subfield 430, a Nsym (or Length) subfield 432, a STA-ID subfield 434, an MCS subfield 436, a Coding subfield 438, a 2×1944 subfield 440, an LDPC Extra Symbol Segment subfield 442, and a Reserved bits subfield 444. In this embodiment, no BSS color bits are included in the ELR-SIG field 428 with the assumption that the ELR Mark Field 216 can distinguish a BSS color, thereby reducing the possibility of OBSS false triggers. The total number of bits of the (concise) ELR-SIG field 428 of this example is 30-31 bits. In an alternate embodiment, the 2×1944 subfield 440 is omitted as the payload of the ELR PPDU may be limited to ˜8000 bits in view of the total PPDU duration. In another alternate embodiment, the ELR-SIG field 428 includes a Beamforming subfield.

FIG. 4D illustrates another example of a single symbol ELR-SIG field 446 in accordance with an embodiment of the present disclosure. The ELR-SIG field 446 of the illustrated example includes a BSS Color subfield 448, a TXOP subfield 450, a Nsym (or Length) subfield 452, a STA-ID subfield 454, an MCS subfield 456, a Coding subfield 458, a 2x1944 subfield 460, an LDPC Extra Symbol Segment subfield 462, a Pre-FEC Padding subfield 464, and a Reserved bits subfield 466. The total number of bits of the ELR-SIG field 446 of this example is 38-39 bits. In an alternate embodiment, the ELR-SIG field 446 includes a PE Disambiguity bit.

FIG. 4E illustrates another example of a single symbol ELR-SIG field 468 in accordance with an embodiment of the present disclosure. The ELR-SIG field 468 of the illustrated example includes a Version ID subfield 470, a PPDU BW subfield 472, an UL/DL subfield 474, a BSS Color subfield 476, a TXOP subfield 478, a Nsym (or Length) subfield 480, a PPDU Type subfield 482, a GI subfield 484, a STA-ID subfield 486, an MCS subfield 488, a Beamformed subfield 490, a Coding subfield 492, a 2×1944 subfield 494, an LDPC Extra Symbol Segment subfield 496, a Pre-FEC Padding subfield 497, a PE Disambiguity subfield 498, and a Reserved bits subfield 499. The total number of bits of the ELR-SIG field 468 of this example is 50 bits.

In the foregoing examples of an ELR-SIG field, various legacy subfields have been or may be omitted. In an example, a PE Disambiguity subfield may be omitted due to a relatively low data rate for the ELR PPDU or when a packet extension (PE) duration is defined (e.g., 4 us or 8 us). In another example, a Pre-FEC padding subfield may be omitted when an a_init value is fixed. In this example, the encoding process will force a_init=N (1 to 4). Using N=4 as an example, if a_init 32 1 to N-1, the value will be forced to 4. If a_init is greater than 4, an extra LDPC symbol can be added and the value will be forced to 4. The encoding process may further force an a_factor value to a defined value (e.g., 4).

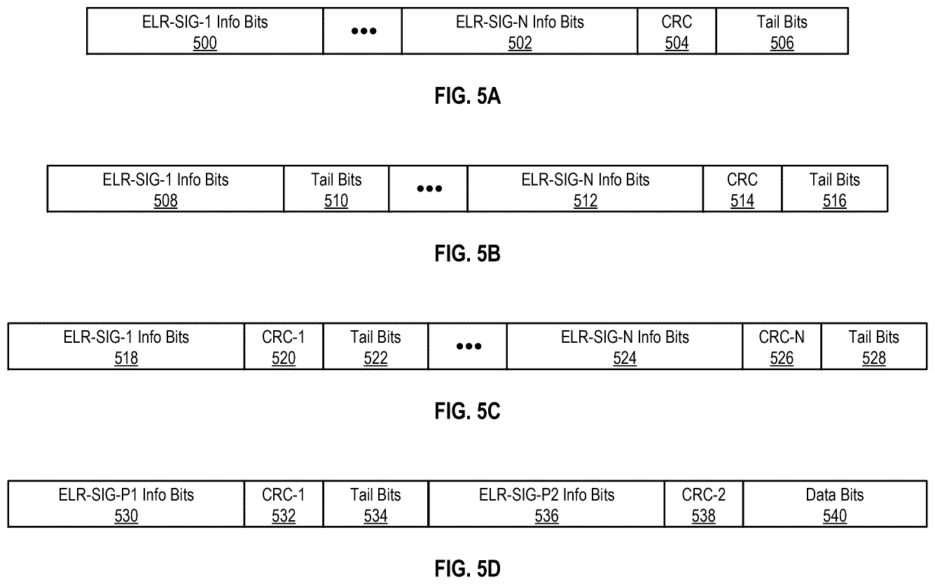

FIG. 5A illustrates an example of coding of an ELR-SIG field in accordance with an embodiment of the present disclosure. In this example, the data bits of the ELR-SIG OFDM symbols 1-N are encoded using a binary convolution code (BCC) and a single CRC (i.e., bits providing a parity check) value is computed for the ELR-SIG symbol contents. The ELR-SIG field of the illustrated example includes ELR-SIG-1 Info bits 500 through ELR SIG-N Info bits 502. In an example, the ELR-SIG field includes ELR-SIG-1 Info bits and ELR-SIG-2 Info bits. The illustrated ELR-SIG field further includes a CRC 504 value for the ELR-SIG info bits and tail bits 506.

FIG. 5B illustrates another example of coding of an ELR-SIG field in accordance with an embodiment of the present disclosure. In this example, the data bits of the ELR-SIG OFDM symbols 1-N are BCC encoded and tail bits are added for each symbol to improve decoding performance. The ELR-SIG field of this example includes ELR-SIG-1 Info bits 508 followed by tail bits 510. One or more additional ELR-SIG info bits (not separately illustrated) followed by tail bits may be included. In this example, the last/second ELR-SIG-N Info bits 512 are followed by a CRC 514 value for the ELR-SIG info bits and tail bits 516.

FIG. 5C illustrates another example of coding of an ELR-SIG field in accordance with an embodiment of the present disclosure. In this example, the data bits of the ELR-SIG OFDM symbols 1-N (e.g., ELR-SIG-1 230 and ELR-SIG-2 232) are BCC encoded and a CRC value and tail bits are added for each symbol. In one embodiment, each CRC is generated from the information bits in the corresponding symbol. The ELR-SIG field of this example includes ELR-SIG-1 Info bits 518 followed by a CRC-1 520 value for the ELR-SIG-1 Info bits and tail bits 522. Likewise, the second (or last) ELR-SIG-N Info bits 524 are followed by a CRC-N 526 value and tail bits 528. In an alternate example, the ELR-SIG field is encoded using a low-density parity check (LDPC) code and the tail bits may be omitted.

FIG. 5D illustrates another example of coding of an ELR-SIG field in accordance with an embodiment of the present disclosure. In this example, a group of information bits (ELR-SIG-P1 Info bits 530) is BCC encoded in one ELR symbol and the remaining Info bits (ELR-SIG-P2 Info bits 536) are encoded with ELR data bits 540 (e.g., BCC or LDPC encoded). In addition, a CRC-1 532 value may be added for ELR-SIG-P1 Info bits 530, followed by tail bits 534. In another example, a CRC-2 538 value may also be added for the ELR-SIG-P2 Info bits 536.

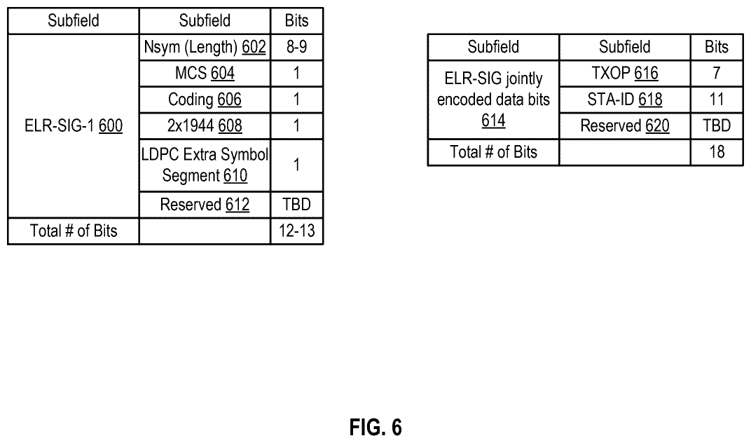

FIG. 6 illustrates an example of an ELR-SIG field in which some subfields are jointly encoded with data such as described above with reference to FIG. 5D. In this example, various information bits of an ELR-SIG field are encoded (e.g., BCC or LDPC encoded) in an ELR-SIG-1 symbol 600, while the remaining information bits are jointly encoded together with ELR data bits. The ELR-SIG-1 symbol 600 of this example generally includes data modulation related bits that may be needed to decode the ELR data bits, including an Nsym (or Length) subfield 602, an MCS subfield 604, a coding subfield 606, a 2×1944 subfield 608, and LDPC Extra Symbol Segment subfield 610, and one or more Reserved bits 612. The total number of bits of the ELR-SIG-1 symbol 600 in this example, exclusive of any appended CRC bits and/or tail bits, is 12-13 bits but may vary depending on the included subfields. Continuing with this example, the ELR-SIG jointly encoded data bits 614 (e.g., jointly encoded with ELR data bits 540) include a TXOP subfield 616, a STA-ID subfield 618 and one or more Reserved bits 620 (approximately 18 total bits). More generally, in the foregoing examples CRC bits can be added for portions of the ELR-SIG bits, and calculation field for the CRC bits is not limited to the content of each ELR-SIG symbol.

The L-SIG field and RL-SIG field, as well as the U-SIG field of an ELR PPDU may have a lower detection SNR than the ELR portion, which might cause false signaling information detection results in certain situations. In an example, L-SIG field and U-SIG field content decoding may not be guaranteed at an ELR receiver. As described herein, various critical bits of these fields are re-signaled in the ELR-SIG field (e.g., the ELR-SIG-1 230 and/or ELR-SIG-2 232 of FIG. 2A). For example, various U-SIG overflow bits (e.g., as included in a legacy EHT-SIG field) and user info bits can be included in the ELR-SIG field. FIGS. 7-9 are included below to illustrate various of the critical bits that can be included in the disclosed ELR-SIG field.

Referring more specifically to FIG. 7, an example of a universal signaling (U-SIG) field is illustrated. The U-SIG field of this example includes a U-SIG-1 subfield 700 and a U-SIG-2 subfield 716. The subfields of the illustrated U-SIG-1 subfield 700 and U-SIG-2 subfield 716 generally correspond to the U-SIG format for a MU PPDU introduced in the 802.11be amendment to the IEEE 802.11 standard, and include a Version Identifier subfield 702, a PPDU BW subfield 704, an UL/DL subfield 706, a BSS Color subfield 708, a TXOP subfield 710, a Disregard bits subfield 712, and a Validate bits subfield 714. In an example, the bits of the Disregard bits subfield 712 and the Validate bits subfield 714 are all set to 1. The illustrated U-SIG-2 subfield 716 includes a PPDU Type And Compression Mode subfield 718, a Validate bit subfield 720, a Punctured Channel Indication subfield 722, a Validate bit subfield 724, an EHT-SIG MCS subfield 726, a Number of EHT-SIG Symbols subfield 728, a CRC in U-SIG subfield 730, and a Tail in U-SIG bit subfield 732.

With reference to FIG. 2A, in an example the U-SIG-1 subfield 226 includes each of the subfields of the U-SIG-1 subfield 700 (e.g., for purposes of forward compatibility and providing options for defining extended range signaling in future generations of the 802.11 standard), and the U-SIG-2 subfield 228 includes a subset of one or more of the subfields of U-SIG-2 subfield 716 in combination with other subfields. In a non-limiting example, the U-SIG-2 subfield 228 may include a PPDU Type And Compression Mode subfield, an association ID (STA-ID) subfield, Validate bits, a CRC subfield, and tail bits.

FIG. 8 illustrates an example of a EHT signaling (EHT-SIG) field 800, while FIG. 9 illustrates an example of a User Info subfield 900 as defined in the IEEE 802.11be amendment to the 802.11 standard. In particular, FIG. 8 illustrates a common field for an EHT SU transmission and non-OFDMA transmission to multiple users, while FIG. 9 illustrates a user field format for a non-MU-MIMO allocation. The EHT-SIG field 800 includes a Spatial Reuse subfield 802, a GI+LTF Size subfield 804, a Number of EHT-LTF Symbols subfield 806, an LDPC Extra Symbol Segment subfield 808, a Pre-FEC Padding subfield 810, a PE Disambiguity subfield 812, a Disregard bits subfield 814, and a Number of Non-OFDMA Users subfield 816. The User Info subfield 900 of FIG. 9 includes a STA-ID subfield 902, an MCS subfield 904, a Reserved bit subfield 906, a Nss subfield 908, a Beamformed subfield 910, and a Coding subfield 912.

As discussed above with reference to FIG. 7, one or more of the subfields may be included in U-SIG-1 subfield 226 and/or U-SIG-2 subfield 228, while it is anticipated that other EHT subfields will not be required (e.g., based on the defined construction of the ELR PPDU). For example, U-SIG-1 subfield 226 and/or U-SIG-2 subfield 228 (and ELR-SIG-1 230 and/or ELR-SIG-2 232) may include a STA-ID subfield, while the Pre-FEC Padding subfield 810 and PE Disambiguity subfield 812 can be omitted if an a_factor value is fixed at 4 and there is no packet extension. Similarly, the GI+LTF Size subfield 804 can be omitted as the U-SIG precedes the ELR-SIG and the GI of the ELR data symbols is expected to be fixed.

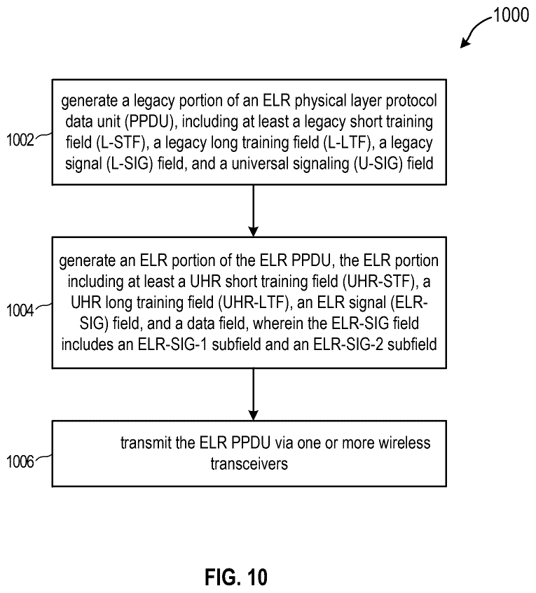

FIG. 10 is a logic diagram 1000 illustrating an example process for generating a ELR PPDU for performing range extension in wireless communications in accordance with an embodiment of the present disclosure. The illustrated functions can be performed by a wireless communication device, such as AP 102 or a client station 116 described with reference to FIG. 1, to generate and transmit an ELR PPDU for reception by another wireless device.

The illustrated method begins at step 1002 where the wireless communications device generates a legacy portion of an ELR PPDU. The legacy portion comprises one or more of a legacy short training field (L-STF), a legacy long training field (L-LTF), a legacy signal (L-SIG) field, and a universal signaling (U-SIG) field. In an example, the legacy portion of the ELR PPDU further includes an ELR-MARK field that includes a BSS color indication. Continuing with this example, the ELR-MARK field may follow the U-SIG field of the ELR PPDU and precede the ELR portion of the ELR PPDU. In another example, the legacy portion may comply with the IEEE 802.11be amendment or the IEEE 802.11ax amendment to the 802.11 standard. If a first wireless device transmits the PPDU and a second wireless device is not able to receive and decode the legacy portion of the PPDU, the second wireless device may attempt to decode an ELR portion of the PPDU.

The method continues at step 1004 where the wireless communication device generates an ELR portion of the ELR PPDU, the ELR portion including a UHR short training field (UHR-STF), a UHR long training field (UHR-LTF), an ELR signal (ELR-SIG) field, and a data field. Various examples of the contents and organization of the ELR portion of the ELR PPDU are described above. In a non-limiting example, the ELR-SIG field includes an ELR-SIG-1 subfield and an ELR-SIG-2 subfield carried in separate OFDM symbols. In another example, the ELR-SIG field includes a single symbol. In yet another example, each of the ELR-SIG-1 subfield and the ELR-SIG-2 subfield includes an independent CRC subfield and a tail bits subfield. In another example, the ELR-SIG-1 subfield includes at least a modulation and coding scheme (MCS) subfield, a coding subfield that indicates whether BCC or LDPC is used, and a number of symbols (Nsym) or Length subfield that indicates a number of ELR data symbols, while the ELR-SIG-2 subfield includes an association ID (STA-ID) subfield. In this example, the ELR-SIG-1 subfield or the ELR-SIG-2 subfield may include an LDPC Extra OFDM Symbol subfield. In yet another example, the ELR PPDU has a 20 MHz PPDU bandwidth and the ELR-SIG-1 subfield and the ELR-SIG-2 subfield are BCC encoded at a rate of R=1/2 (e.g., with BPSK modulation and 1/2(MSC0)). In a further example, the ELR-SIG-1 subfield and the ELR-SIG-2 subfield are BCC encoded at a rate of R=1/3 with BPSK modulation.

The method continues at step 1006, where the wireless communication device transmits the ELR PPDU, via one or more wireless transceivers, for reception by one or more other wireless communication devices (e.g., devices at an extended range). A recipient device may respond with a similarly constructed ELR PPDU. In an example, the ELR PPDU and fields thereof are transmitted as one or more waveforms, and one or more repetitions of a field may be transmitted to increase a signal-to-noise ratio (SNR) of the ELR portion of the ELR PPDU to facilitate decoding of the field. For example, repetition of a field (e.g., as described with reference to FIG. 11) may increase an associated SNR by greater than 3 dB through averaging of signals associated with the repetitions.

FIG. 11 illustrates example functions 1100 associated with single carrier-frequency division multiplexed (SC-FDM) transmission of the ELR-SIG field 222 and UHR-Data field 224 in accordance with an embodiment (e.g., using the ELR PPDU 200 of FIG. 2A as an example). The functions 1100 include bit processing 1102 a binary sequence/stream associated with a field of the ELR PPDU, a discrete Fourier transform (DFT) 1104, a tone mapping 1106, an inverse DFT (IDFT) 1108, and guard band insertion 1110. At 1102, the bit processing 1102 performs one or more of encoding, scrambling, and/or modulation of a binary sequence of a field in a time domain. At 1104, a DFT of the processed binary sequence of the ELR-SIG field 222/UHR-Data field 224 is generated followed by a tone mapping 1106. The tone mapping 1106 operates to populate the processed information bits in the frequency domain onto subcarriers which span a channel bandwidth such as a 20 MHz channel. Further, the population onto subcarriers may include mapping the processed binary sequence in the frequency domain to a resource unit which defines a plurality of tones for carrying the data. The tones can be contiguous or distributed. In an example, the bit processing 1102 performs a precoding of the information bits prior to the tone mapping 1106 to reduce a peak to average ratio (PAPR) of a waveform prior to transmission. The IDFT 1108 generates a SC-FDM symbol which spans a channel bandwidth and the guard band insertion 1110 inserts guard intervals (e.g., to separate the symbols from interference). In an example, the guard interval for an ELR-SIG symbol is fixed at 0.8 us, 1.6 us or 3.2 us. SC-FDM can be easily extended to a multiple user case, where each user is assigned to a subset of tones in the resource unit, i.e., each wireless device modulates its data (after DFT) onto a different set of tones to facilitate extending range for uplink (UL) transmissions to multiple clients. For SC-FDM (A) mode, in one variant, the ELR-SIG field 222 may be transmitted with SC-TDM, while the UHR-Data field 224 may be transmitted with SC-FDM.

A tone map for the ELR-SIG field 222 and UHR-Data field 224 transmitted using SC-FDM may be arranged as a 20 MHz ELR PPDU: ELR-SIG field 222 and UHR-Data field 224 can be defined as one or more of an 802.11a/g tone plan, e.g., 64-point FFT with 48 loaded data tones and 4 pilot tones, an 802.11n/ac 20 MHz tone plan, e.g., 64-point FFT with 52 loaded data tones and 4 pilot tones (or 56 loaded data tones), or an 802.11ax/be 20 MHz tone plan, e.g., coded bit repetition using 256-point FFT and 234 loaded data tones and 8 pilot tones, or a sparse tone loading, e.g., 256-point FFT with 52 or 56 loaded data tones spaced every four tones (with channel estimation obtained from L-LTF, L-SIG, RL-SIG and/or an ELR-MARK subfield), etc. The tones may be subcarriers with a predefined frequency to carry indications of bits in fields of the ELR PPDU 200.

In another example, a wider bandwidth ELR PPDU 200 may be defined for a spectrum with a low power spectral density (PSD) requirement, e.g. 6 GHz low power indoor (LPI) operation. The ELR preamble may be transmitted in a 20 MHz bandwidth. To accommodate coexisting with wireless devices with different operating bandwidths, a wide bandwidth ELR preamble may be defined based on repetition of the 20 MHz ELR preamble across entire signal BW, e.g., 80 MHz, or a per-20 MHz tone polarity change can be applied to a phase of a tone which is waveform modulated with one or more bits of a binary sequence in the repetitions of the ELR preamble. The polarity change of −1 may change the phase of a waveform by 180 degrees while a polarity change of 1 may not change the phase of a waveform by 180 degrees. The changes in polarity may be known to the receiver to remove the polarity changes during a decoding process. The term repetition, repeated, and similar variations as used herein with respect to a field means that tones of two fields are the same after any applied polarity is removed.

In another example, the binary sequence of one or more fields of the ELR portion of the ELR PPDU 200 may be further repeated to improve communication range. Further, a binary sequence of the ELR portion may be defined as a waveform with OFDM modulation. The repetition may be in a time domain or in a frequency domain. In an example, the repetition (also referred to as duplication) may be a repetition of one or more orthogonal frequency division multiplexed/multiple access (OFDM/A) symbols in time with a same binary sequence, a repetition in frequency of a same binary sequence in one or more orthogonal frequency division multiplexed/multiple access (OFDM/A) symbols, or a repetition in time and frequency.

While the innovate aspects of the present disclosure have been generally described in the context of the 802.11bn amendment, and future generations, of the IEEE 802.11 standard, a person having ordinary skill in the art will readily recognize that teachings herein may be applied to other wireless networks and standards including, for example, Long Term Evolution (LTE) standards and Bluetooth standards.

The innovative methods and apparatus illustrated in the drawings and described herein provide for reliable long range wireless communications. In an illustrative, non-limiting embodiment, a method for performing an Enhanced Long Range (ELR) wireless communication is provided. The method includes generating, by a first device, a legacy portion of an ELR physical layer protocol data unit (PPDU), the legacy portion including at least a legacy short training field (L-STF), a legacy long training field (L-LTF), a legacy signal (L-SIG) field, and a universal signaling (U-SIG) field. The method further includes generating, by the first device, an ELR portion of the ELR PPDU, the ELR portion including at least a UHR short training field (UHR-STF), a UHR long training field (UHR-LTF), an ELR signal (ELR-SIG) field, and a data field. The ELR-SIG field includes an ELR-SIG-1 subfield and an ELR-SIG-2 subfield. The first device of this method transmits the ELR PPDU over a wireless interface for reception by a second device.

The method of this embodiment includes optional aspects. With one optional aspect, the legacy portion of the ELR PPDU further includes an ELR-MARK field, the ELR-MARK field including a BSS color indication. With another optional aspect, the ELR-MARK field follows the U-SIG field and precedes the UHR-STF. In yet another optional aspect, the ELR-SIG field follows the UHR-STF and the UHR-LTF and is carried in two OFDM symbols. In a further optional aspect, each of the ELR-SIG-1 subfield and the ELR-SIG-2 subfield includes an independent CRC subfield and a tail bits subfield. With another optional aspect, the ELR-SIG-1 subfield includes at least a modulation and coding scheme (MCS) subfield, a coding subfield that indicates whether BCC or LDPC is used, and Length subfield that indicates a number of ELR data symbols. In another optional aspect, the ELR-SIG-2 subfield includes an association ID (STA-ID) subfield.

In another optional aspect of this embodiment, the ELR-SIG-1 subfield or the ELR-SIG-2 subfield includes an LDPC Extra OFDM Symbol subfield. With another optional aspect, the ELR PPDU has a 20 MHz PPDU bandwidth. In a further optional aspect, the ELR-SIG-1 subfield and the ELR-SIG-2 subfield are BCC encoded at a rate of R=1/2. In yet another optional aspect, transmitting the ELR PPDU includes transmitting the ELR-SIG field and the data field using a common tone plan and frequency domain duplication scheme.

With another illustrative, non-limiting embodiment, a communication device includes one or more wireless transceivers, memory including operational instructions, and one or more processing modules operably coupled to the one or more wireless transceivers and the memory. The one or more processing modules are configured to execute the operational instructions to generate a legacy portion of an ELR physical layer protocol data unit (PPDU), the legacy portion including a legacy short training field (L-STF), a legacy long training field (L-LTF), a legacy signal (L-SIG) field, and a universal signaling (U-SIG) field. The one or more processing modules of the communication device are further configured to generate an ELR portion of the ELR PPDU, the ELR portion including a UHR short training field (UHR-STF), a UHR long training field (UHR-LTF), an ELR signal (ELR-SIG) field, and a data field, the ELR-SIG field including an ELR-SIG-1 subfield and an ELR-SIG-2 subfield, and transmit the ELR PPDU via the one or more wireless transceivers.

This embodiment includes optional aspects. With one optional aspect, the legacy portion of the ELR PPDU further includes an ELR-MARK field, the ELR-MARK field including a BSS color indication. With another optional aspect, the ELR-MARK field follows the U-SIG field and precedes the UHR-STF. In yet another optional aspect, the ELR-SIG field follows the UHR-STF and the UHR-LTF and is carried in two OFDM symbols. In a further optional aspect, each of the ELR-SIG-1 subfield and the ELR-SIG-2 subfield includes an independent CRC subfield and a tail bits subfield. With another optional aspect, the ELR-SIG-1 subfield includes at least a modulation and coding scheme (MCS) subfield, a coding subfield that indicates whether BCC or LDPC is used, an LDPC Extra OFDM Symbol subfield, and a Length subfield that indicates a number of ELR data symbols. In this optional aspect, the ELR-SIG-2 subfield includes an association ID (STA-ID) subfield. In yet another optional aspect, the ELR-SIG-1 subfield and the ELR-SIG-2 subfield are BCC encoded at a rate of R=1/2.

With another illustrative, non-limiting embodiment, a method for performing an Enhanced Long Range (ELR) wireless communication is provided. The method includes generating, by a first device, a legacy portion of an ELR physical layer protocol data unit (PPDU), the legacy portion including a legacy short training field (L-STF), a legacy long training field (L-LTF), a legacy signal (L-SIG) field, and a universal signaling (U-SIG) field. The method further includes generating, by the first device, an ELR portion of the ELR PPDU, the ELR portion including a single symbol ELR signal (ELR-SIG) field, an ELR-MARK field, a UHR short training field (UHR-STF), a UHR long training field (UHR-LTF), and a data field. The first device of this method transmits the ELR PPDU over a wireless interface for reception by a second device. In an optional aspect of this third embodiment, the ELR-SIG field includes at least a modulation and coding scheme (MCS) subfield, a coding subfield that indicates whether BCC or LDPC is used, and a Length subfield that indicates a number of ELR data symbols.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for performing an Enhanced Long Range (ELR) wireless communication, comprising:
generating, by a first device, a legacy portion of an ELR physical layer protocol data unit (PPDU), the legacy portion including at least a legacy short training field (L-STF), a legacy long training field (L-LTF), a legacy signal (L-SIG) field, and a universal signaling (U-SIG) field;
generating, by the first device, an ELR portion of the ELR PPDU, the ELR portion including at least an Ultra High Reliability (UHR) short training field (UHR-STF), a UHR long training field (UHR-LTF), an ELR signal (ELR-SIG) field, and a data field, wherein the ELR-SIG field includes an ELR-SIG-1 subfield and an ELR-SIG-2 subfield; and
transmitting the ELR PPDU over a wireless interface for reception by a second device.

2. The method of claim 1, wherein the legacy portion of the ELR PPDU further includes an ELR-MARK field, the ELR-MARK field including a Basic Service Set (BSS) color indication.

3. The method of claim 2, wherein the ELR-MARK field follows the U-SIG field and precedes the UHR-STF.

4. The method of claim 1, wherein the ELR-SIG field follows the UHR-STF and the UHR-LTF and is carried in two orthogonal frequency division multiplexed (OFDM) symbols.

5. The method of claim 1, wherein each of the ELR-SIG-1 subfield and the ELR-SIG-2 subfield includes an independent cyclic redundancy check (CRC) subfield and a tail bits subfield.

6. The method of claim 1, wherein the ELR-SIG-1 subfield includes at least a modulation and coding scheme (MCS) subfield, a coding subfield that indicates whether binary convolutional coding (BCC) or low density parity check code (LDPC) is used, and a Length subfield that indicates a number of ELR data symbols.

7. The method of claim 6, wherein the ELR-SIG-2 subfield includes an association ID (STA-ID) subfield.

8. The method of claim 6, wherein the ELR-SIG-1 subfield or the ELR-SIG-2 subfield includes an LDPC Extra OFDM Symbol subfield.

9. The method of claim 1, wherein the ELR PPDU has a 20 MHz PPDU bandwidth.

10. The method of claim 1, wherein the ELR-SIG-1 subfield and the ELR-SIG-2 subfield are BCC encoded at a rate of R=1/2.

11. The method of claim 1, wherein transmitting the ELR PPDU includes transmitting the ELR-SIG field and the data field using a common tone plan and frequency domain duplication scheme.

12. A communication device, comprising:
one or more wireless transceivers;
memory including operational instructions; and
one or more processing modules operably coupled to the one or more wireless transceivers and the memory, wherein the one or more processing modules are configured to execute the operational instructions to:
generate a legacy portion of an ELR physical layer protocol data unit (PPDU), the legacy portion including a legacy short training field (L-STF), a legacy long training field (L-LTF), a legacy signal (L-SIG) field, and a universal signaling (U-SIG) field;
generate an ELR portion of the ELR PPDU, the ELR portion including an Ultra High Reliability (UHR) short training field (UHR-STF), a UHR long training field (UHR-LTF), an ELR signal (ELR-SIG) field, and a data field, wherein the ELR-SIG field includes an ELR-SIG-1 subfield and an ELR-SIG-2 subfield; and
transmit the ELR PPDU via the one or more wireless transceivers.

13. The communication device of claim 12, wherein the legacy portion of the ELR PPDU further includes an ELR-MARK field, the ELR-MARK field including a Basic Service Set (BSS) color indication.

14. The communication device of claim 13, wherein the ELR-MARK field follows the U-SIG field of the ELR PPDU and precedes the UHR-STF.

15. The communication device of claim 12, wherein the ELR-SIG field follows the UHR-STF and the UHR-LTF and is carried in two orthogonal frequency division multiplexed (OFDM) symbols.

16. The communication device of claim 12, wherein each of the ELR-SIG-1 subfield and the ELR-SIG-2 subfield includes an independent cyclic redundancy check (CRC) subfield and a tail bits subfield.

17. The communication device of claim 12, wherein the ELR-SIG-1 subfield includes at least a modulation and coding scheme (MCS) subfield, a coding subfield that indicates whether binary convolutional coding (BCC) or low density parity check code (LDPC) is used, an LDPC Extra OFDM Symbol subfield, and a Length subfield that provides an indication of a number of ELR data symbols, and wherein the ELR-SIG-2 subfield includes an association ID (STA-ID) subfield.

18. The communication device of claim 12, wherein the ELR-SIG-1 subfield and the ELR-SIG-2 subfield are BCC encoded at a rate of R=1/2.

19. A method for performing an Enhanced Long Range (ELR) wireless communication, comprising:
generating, by a first device, a legacy portion of an ELR physical layer protocol data unit (PPDU), the legacy portion including at least a legacy short training field (L-STF), a legacy long training field (L-LTF), a legacy signal (L-SIG) field, and a universal signaling (U-SIG) field;
generating, by the first device, an ELR portion of the ELR PPDU, the ELR portion including a single symbol ELR signal (ELR-SIG) field, an ELR-MARK field, an Ultra High Reliability (UHR) short training field (UHR-STF), a UHR long training field (UHR-LTF), and a data field; and
transmitting the ELR PPDU over a wireless interface for reception by a second device.

20. The method of claim 19, wherein the ELR-SIG field includes at least a modulation and coding scheme (MCS) subfield, a coding subfield that indicates whether binary convolutional coding (BCC) or low density parity check code (LDPC) is used, and a Length subfield that indicates a number of ELR data symbols.
